(19) United States
(12) Patent Application Publication
(10) Pub. No.: US 2006/0149783 A1
(43) Pub. Date: Jul. 6, 2006

(54) 2 Dimensional structure queries

(76) Inventors: Mathew Harrison, Camperdown (AU); Hiren Joshi, Eastwood (AU); Catherine Anne Liddell, Mt. Colah (AU)

Correspondence Address: BOZICEVIC, FIELD & FRANCIS LLP, 1900 UNIVERSITY AVENUE, SUITE 200, EAST PALO ALTO, CA, 94303, US

(21) Appl. No.: 10/499,237

(22) PCT Filed: Dec. 30, 2002
(86) PCT No.: PCT/AU02/01752

§ 371 Date: Oct. 27, 2005

(30) Foreign Application Priority Data
Jan. 2, 2002 (AU) PR9810

(51) Int. Cl. G06F 7/00

(52) U.S. Cl. 707/104.1

(57) ABSTRACT

This invention concerns 2 Dimensional structure queries. Each structure comprises an array of nodes connected together by linkages to form one or more branches, or children, extending from a root, or reducing terminus. Each structure is represented using a sequence code generated to represent all the paths through the structure starring from the distal end, or leaf, of each branch and extending back to the root. The sequence code is governed by rules which guarantee there is a single unique representation for any structure. In particular one aspect of the invention concerns a database of 2 Dimensional structures, such as carbohydrate molecular structures. In another aspect the invention concerns a process for constructing such a database. Perhaps most importantly, in a further aspect the invention concerns a process for searching such a database to find all the structures that contain a given substructure within them.

### TECHNICAL FIELD

This invention concerns 2 Dimensional structure queries. In particular one aspect of the invention concerns a database of 2 Dimensional structures, such as carbohydrate molecular structures. In another aspect the invention concerns a process for constructing such a database. Perhaps most importantly, in a further aspect the invention concerns a process for searching such a database to find all the structures that contain a given substructure within them.

### BACKGROUND ART

In the present art, biotechnology researchers who are working to understand the structure of branched glycans pursue an approach which encompasses the following procedure: Branched structures of glycans, which are held in a glycan structure database, are represented in a linear sequence format. This permits text-based searching for desired structures that may exist within the glycan. Thus searching for non-branched substructures can be undertaken. Alternatively, limited branch structure sequencing may be also undertaken (within the limits of the linear text format).

However, searching may be limited in that not all structures with a given substructure may be found. Other branches that originate from or include the search substructure may be hidden by the presence of nested branch sequences that interrupt the continuous sequence of the search substructure. Therefore a particular substructure may not be recognized to exist within a particular biological source. This can lead to incorrect assessment of substructures in glycans.

### SUMMARY OF THE INVENTION

In a first aspect, the invention is a database of 2 Dimensional structures, such as carbohydrate molecular structures, each structure comprising an array of nodes, such as monosaccharides, connected together by linkages to form one or more branches, or children, extending from a root, or reducing terminus; where each structure is represented using a sequence code generated to represent all the paths through the structure starting from the distal end, or leaf, of each branch and extending back to the root, the sequence code being governed by rules which guarantee there is a single unique representation for any structure.

The sequence code is able to be converted into a computer model which is a n-ary tree.

The rules may sort the branched children of a structure, in order of. priority, by:

increasing linkage, that is from lowest to highest; then,

length, that is longest to shortest; then,

alphabetically, that is from ‘a’ to ‘z’; and then,

number of children, that is highest number first

This ordering will ensure that structures with unknowns are represented uniquely, and that the resultant sequence will have branches ordered so that if there are two branches which are identical, except for an extra element or branch (either on the end or along the branch), the larger branch will always be on the left in the sequence generated.

The paths through a structure are defined as leading from the leaves of the structure to the root.

Such a database may be used to represent carbohydrate molecules, more particularly sugars, and in particular, although not exclusively, glycan structures.

In a second aspect, the invention is a process for constructing such a database, the method comprising the following steps:

Selecting a set of possible structures which may contain desired substructures.

Representing each possible structure as a series of paths leading from the distal end of each branch back to root of the structure.

Representing all the paths of each structure using a sequence code generated by rules which guarantee there is a single unique representation for any structure.

In a third aspect, the invention is a process for searching such a database to find all the structures that contain a given substructure within them, the method comprising the following steps:

Parsing a query substructure into linear query paths, each of which extends from the distal end of a branch to the root of its structure.

Inserting the query paths into the database.

Identifying a list of candidate structures in the database which contain the same linear paths as the query paths.

The identifying step may be done by first identifying a first set of candidates that contain a linear path the same as a first query path, then identifying a second set of candidates, from the first set, that also contain a linear path the same as a second query path, and so on until a list is identified of candidate structures containing all the query paths.

Then, validating the list of candidate structures, by testing each candidate structure using a tree searching algorithm to determine whether it has the same topology within it as the query structure, to produce a validated list of candidate structures which contain the same linear paths as the query structure arranged with the same topology. The validated list will typically have one or more entries indicating a match for the query structure has been found within one or more of the structures in the database, or no entries indicating there is no match in the database.

The validating step may be done by:

Parsing the listed candidate structures and the query structure to create objects.

Testing each candidate structure object in turn;

Traversing each node in the candidate structure under test, starting from the root.

Checking, at every node, whether the type (name) of the node (monosaccharide) is the same as that of the root in the query structure.

Determining that the query structure exists in the candidate structure if the query tree root node has no children.

Determining that the query structure does not exist in the candidate structure rooted at that node if the query tree root node has more branches, children, than the current node.

Otherwise, determining that the query structure does not exist rooted at the current node if any of the linkages between the query tree root node and its children do not exist between the current node and its children.

The order in which linkages are checked are from lowest non-reducing terminal linkage to highest non-reducing terminal linkage. Unknown linkages being sorted higher than other linkages. The ordering of branches ensures that the largest branches are always searched for first.

A process of recursive elimination may be used to verify that the query structure exists rooted at the current node. This procedure proceeds to find a match between a candidate and query linkage, and if so to check the children of both the query and candidate on the linkage.

If at any time a match does not occur between the children/linkages/names, the two branches are not considered as matched.

Otherwise, the branches are considered as matched, and the linkage used right at the start of the procedure is marked as eliminated, and will not be checked again.

Unknown linkages are dealt with by allowing for wild-cards within the query paths. The wild-cards would match up with any value. If a branch is attached on an unknown linkage, the process will check to see if the branch exists firstly in the list of known branches followed by the unknown branches.

It will be evident that this approach, when applied to glycan structure searching, permits rapid and correct identification of glycan structures containing significant branching and specific epitopes that may be of biological importance.

In the hands of a biological researcher, the identification of structures existing in a diseased state may be characterized for subsequent drug targetting. Alternatively, the approach can identify if a particular structure is produced by certain species enabling the identification of possible recombinant systems.

### BRIEF DESCRIPTION OF THE DRAWINGS

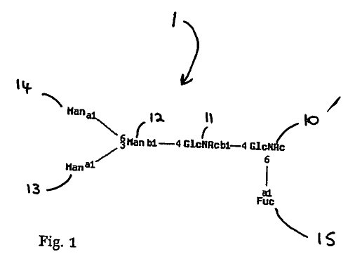

The invention will now be described with reference to several examples. One example involves the structure illustrated in FIG. 1.

### BEST MODE OF THE INVENTION

An example of the invention will now be described with reference to a technique for performing structure queries on two structures contained within the GlycoSuiteDB database.

The two structures, or candidates, that define the solution space, are:

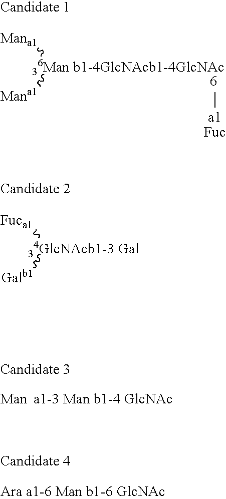

The solution space is prepared by calculating and comparing the paths through all the candidate structures in the database. Remembering that the paths through a structure are defined as the paths leading from the leaves of the structure to the root, the paths through the candidate 1 structure: 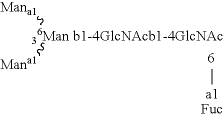
Are:
Man a1-6 Man b1-4 GlcNAcb1-4 GlcNAc Path 1—candidate 1
Man a1-3 Man b1-4 GlcNAcb1-4 GlcNAc Path 2—candidate 1
Fuc a1-6 GlcNAc Path 3—candidate 1
Path 1 is found by following a path back up the tree from the uppermost “Man” leaf node (attached on a 6 linkage).
Path 2 is found by following a path back up the tree from the middle “Man” leaf node (attached on a 3 linkage).
Path 3 is found by following a path back up the tree from the “Fuc” leaf node (attached on a 6 linkage).

The paths through the candidate 2 structure: 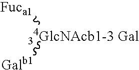
Are:
Gal b1-3 GlcNAcb1-3 Gal Path 1—candidate 2
Fuc a1-4 GlcNAcb1-3 Gal Path 2—candidate 2

There is only one path in the Candidate 3 structure:
Man a1-3 Man b1-4 GlcNAc

And there is only one path in the Candidate 4 structure:
Ara a1-6 Man b1-6 GlcNAc

The paths for all candidate structures in GlycoSuiteDB are calculated and stored for future querying.

Structures are stored in the database using a sequence code. The rules for generating the code guarantee that there is a single unique representation for any structure. The sequences can be converted into a computer model which is essentially a n-ary tree.

Rules are used to decide which internal linkage to use to represent the linkage on unknown branches. In general, for children of a monosaccharide, its branched children are sorted by (in order of priority) increasing linkage, length, alphabetically (based on monosaccharide type names) and number of children. This ordering will ensure that structures with unknowns are represented uniquely, and that the resultant sequence will have branches (represented using “[]”) ordered so that if there are two branches which are identical, except for an extra monosaccharide/branch (either on the end or along the branch), the larger branch will always be on the left in the sequence generated.
For Example the following branches: 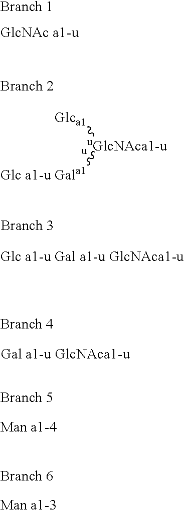
will be ordered as
Branch 6
Branch 5
Branch 2
Branch 3
Branch 4
Branch 1
And the sequence code for this branch will be (assuming all branches are attached to a residue “X” and there is another branch elsewhere in the structure with a longer length):
Man(a1-3) [Man(a1-4)][Glc(a1-?)Gal(a1-?)[Glc(a1-?)]GlcNAc(a1-?)][Glc(a1-?)Gal(a1-?)GlcNAc(a1-?)][Gal(a1-?)GlcNAc(a1-?)][GlcNAc(a1-?)]X

The query structure is the structure that we wish to find in the database, and in this example is:

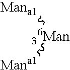

The first step in finding this structure is to calculate its paths through the following query structure, and they are:
Man a1-3 Man Path 1-query
Man a1-6 Man Path 2—query

The next step is a preliminary refinement of the solution space to find a set of candidate structures which may contain the desired substructure. This is done by finding the candidates where every query path can be found within (as a “sub-path”) its paths.

To generate the list of paths to match against, the query structure is processed using a parsing algorithm and then for each leaf in the structure, a path is traced back to the root node. Each one of these paths is inserted into the database.

A searching algorithm starts out initially with a complete set of structures and paths in the database. The first query path is obtained from the query sequence. The set of structures is refined to include only those structures that have at least one path that contains the query path.

Examining the first candidate—we see that Path 1 (query) can be found in Path 2 of candidate 1:

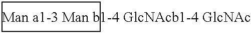

Path 1 (query) is similarly found in Candidate 3.

Examining Candidates 2 and 4—none of the query paths can be found as sub-paths of the candidates 2 and 4 paths.

So, searching for structures that contain Path 1, the solution space is refined to the following as Candidates 2and 4 do not contain Path 1:

| Candidate | Paths |
|---|---|
| 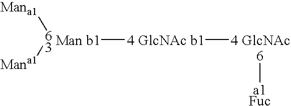 | Man a1—6 Man b1—4 GlcNAcbl—4 GlcNAc Man a1—3 Man b1—4 GlcNAcbl—4 GlcNRc Fuc a1—6 GlcNAc |
| Man a1—3 Man b1—4 GlcNAc | Man a1—3 Man b1—4 GlcNAc |
| Candidate 3 | |

This set of structures is further refined by including only those structures in the set that have at least one path that contains the second query path.

Path 2 (query) can be found in Path 1 of the first candidate:

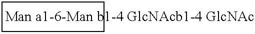

So searching for structures that contain Path 2, the solution space is refined to the following as Candidate 3 does not contain Path 2:

| | |
|---|---|
| Candidate | Paths |
| 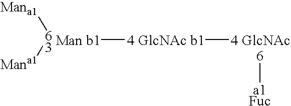 | Man a1—6 Man b1—4 GlcNAcb1—4 GlcNAc Man a1—3 Man b1—4 GlcNAcb1—4 GlcNAc Fuc a1—6 GlcNAc |
| Candidate 1 | |

This continues until either no structure matches, or all query paths have found a match. In this case, Candidate 1 is the only candidate left after the refining process.

It does not matter that there are extra nodes in the tree to the right of the sub-path that we found. It also does not matter if there are extra nodes in the tree to the left of the sub-path that we find too.

Unknown linkages are dealt with by allowing for wild-cards within the query paths. The wild-cards would match up with any value.

Next it is necessary to validate each structure in the set (that is, the set of candidate structures which may contain the desired substructure) to find which ones do contain the desired substructure. This is necessary to refine the solution space to remove any incorrectly matched results, or in other words, remove any false positive results.

False positive results exist if two unknown linkage branches (attached to the same monosaccharide) on the query structure exist (where one branch is a subset of or the same as the other branch), and the candidate structure contains only a single branch with the same composition as the larger of the branches. For Example:

Candidate Structure 5:
Glc a1-4 GlcNAca1-u Man
has a single path:
Glc a1-4 GlcNAca1-u Man
Query Structure 2: 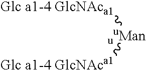
has two paths:
Glc a1-4 GlcNAca1-u Man
Glc a1-4 GlcNAca1-u Man
Query Structure 3: 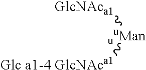
also has two paths:
Glc a1-4 GlcNAca1-u Man
GlcNAca1-u Man

Both Query Structures 2 and 3 will match up with Candidate Structure 5 (by paths only):

However, Query structure 2 has two identical paths whereas Candidate structure 5 has only a single path and clearly cannot be a valid result

Also Query Structure 3 has two paths and Candidate structure 5 cannot be a valid structure as it is smaller than query structure 3.

False positive results also exist if the paths that are found in the candidate structure do not meet at a common point, that is the attachment point of the query structure in the candidate structure. For Example: Candidate Structure 6: 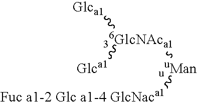
has 3 paths:
Fuc a1-2 Glc a1-4 GlcNAca1-u Man Path 1—candidate 6
Glc a1-3 GlcNAca1-u Man Path 2—candidate 6
Glc a1-6 GlcNAca1-u Man Path 3—candidate 6
Query Structure 4: 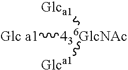
has three paths:
Glc a1-3 GlcNAc Path 1—query 4
Glc a1-4 GlcNAc Path 2—query 4
Glc a1-6 GlcNAc Path 3—query 4
Examining candidate 6—we see that Path 1 (query 4) can be found in Path 2 (candidate 6)
Glc a1-3GlcNRca1-u Man
and that Path 2 (query 4) can be found in Path 1 (candidate 6). 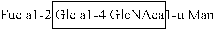
and that Path 3 (query 4) can be found in Path 3 (candidate 6).

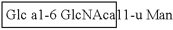

All the paths in the query structure match up, however it can be seen from inspecting the query and candidate structures that the query structure cannot be found within the candidate structure.

To solve these issues, a structure to structure comparison must be made between the query structure and the candidate structure. If a traversal of the candidate structure can produce the query structure then the query structure exists within the candidate structure and is a valid result.

A structure to structure comparison occurs by going to each monosaccharide in a candidate structure, and checking if a query structure rooted at that monosaccharide exists. Monosaccharide type and the number and type of child linkages are examined at each visit to a monosaccharide.

In order to validate that a candidate structure contains a query structure, they are both parsed and used to create objects which model Sugars and Monosaccharides. Sugars are represented as tree structures internally. A tree searching algorithm is used to verify that the query structure is contained within the candidate structure.
For example if we wish to verify that the query structure: 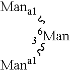
is contained within the candidate structure 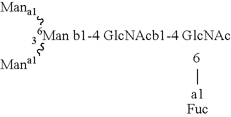
The algorithm used is as follows:
Each node (monosaccharide) is to be traversed in the candidate structure
At every node, if the type (name) of the monosaccharide is the same as that of the root monosaccharide in the query structure, then a search begins to check if the query tree can be found in this tree rooted at the current node.
If the query tree root node has no children, then the query structure exists in the candidate structure
If the query tree root node has more children than the current node, then the query structure does not exist rooted at the current node.
Otherwise, the linkages between the query tree root node and its children are checked to exist in the linkages between the current node and its children. If any of the linkages do not exist the query structure does not exist rooted at the current node, The order in which linkages are checked are from lowest non-reducing terminal linkage to highest non-reducing terminal linkage. A process of recursive elimination is used to verify that the query structure exists rooted at the current monosaccharide.
For example, the order of traversal for the candidate structure is shown in FIG. 1. The Candidate Structure 1 is searched in order from the first monosaccharide visited 10, to the second 11, to the third 12. The query structure is found at this point, and the others would not be checked.
However, the order of continuing search would be 13, 14 and 15.
Recursive elimination is used to see if a query structure is rooted at the current monosaccharide. This procedure proceeds as follows:
When linkages are compared between children in the query and candidate structures, the linkage is checked from lowest to highest
If a match occurs between a candidate and query linkage, the children of both the query and candidate on the linkage are used in another branch elimination procedure.
This tries matching the names of the monosaccharide, and looks at children again (much like above), using the recursive elimination procedure again on any children.
If at any time a match does not occur between the children/linkages/names, the two branches are not considered as matched.
Otherwise, the branches are considered as matched, and the linkage used right at the start of the procedure is marked as eliminated, and will not be checked again.
For example we wish to check whether 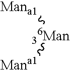
exists rooted at the highlighted monosaccharide in the candidate structure: 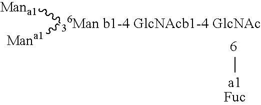
We check that the branches exist in order of ascending linkage (with unknown linkages being sorted higher than other linkages). First we check that
Man a1-3
exists in the candidate structure. This is found in the candidate structure as the child linkage (a1-3) exists on the highlighted monosaccharide, the names of the monosaccharides on the linkage (a1-3) are the same, and this monosaccharide's children also match up (as they both have no children). The branch is pruned off the query structure and the candidate structure.
Query and candidate structures now look like: 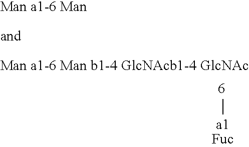
We now need to check that
Man a1-6
exists within the candidate structure. Much like the previous branch, this branch matches up. The branch is pruned off, and we are left with a single Man on the query structure. Since all of the children of the remaining monosaccharide in the query structure have been found, the subtree of the query structure at the remaining monosaccharide can be found in the candidate structure. Also, as the remaining monosaccharide is the root monosaccharide in the query tree the entire query structure can be found in the candidate structure.
Dealing with Unknown linkages
Unknown linkages are modeled as non-reducing terminal values >9 and <13.
If a query root -> child linkage contains an unknown value, current node -> child linkages from 1-13 are checked in the branch elimination procedure.
This ordering is important when searching for branches on unknown linkages. If a branch is attached on an unknown linkage, it will check to see if the branch exists firstly in the list of known branches followed by the unknown branches. It is critical that the query structure have a valid sequence, so that the branches are checked in the correct order. The ordering of branches ensures that the largest branches are always searched for first.
For Example:
This structure has sequence:Ara(a1-3)[Fuc(a1-?)]GlcNAc(a1-2)Glc(a1-?)[Ara(a1-3)GlcNAc(a1-2)Glc(a1-?)]GlcNAc 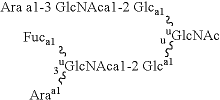
Our query structure is the same structure: 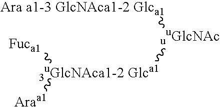
We want to see if the two structures are equal (without simply checking the sequences are equal). Firstly we need to check if the bottom branch of the query structure is contained in the candidate structure. This is achieved by giving the lower branch a lower linkage than the upper branch (as represented internally). If the upper branch was checked first, then there is a chance (depending on the sequence of the candidate structure) that the lower branch in the candidate will match with the upper branch (eliminating it from any further matching) and the lower branch will not match any other branches, resulting in the two structures not matching.
An example of branch elimination using unknowns:
Query Structure: 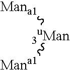
Candidate Structure: 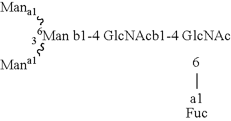
Much like the previous example, we traverse down the tree until we find a monosaccharide with the same name as the root monosaccharide. 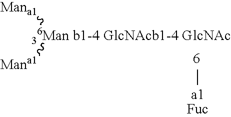
We now proceed to check the branches of the query structure in order of ascending linkage. First we check that
Man a1-3
exists in the candidate structure. This branch exists in the candidate structure. We prune the branch from both the candidate and query structures leaving us with 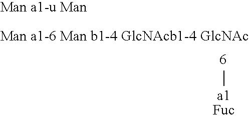
We now check that the branch
Man a1-u
exists in the candidate structure. We check linkages increasing from 1 - 13 to try and find a match. The branches match on (a1-6), so this branch is in the candidate structure and the branch is in the candidate structure. We prune the branch from both the structures, and much like the previous example, the entire query structure can be found in the candidate structure.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. A database of 2 Dimensional structures, wherein each structure comprises an array of nodes connected together by linkages to form one or more branches, or children, extending from a root, or reducing terminus; and wherein each structure is represented using a sequence code generated to represent all the paths through the structure starting from the distal end, or leaf, of each branch and extending back to the root, the sequence code being governed by rules which guarantee there is a single unique representation for any structure.

2. A database according to claim 1, wherein the 2 Dimensional structures are carbohydrate molecular structures.

3. A database according to claim 2, wherein the nodes are monosaccharides.

4. A database according to claim 1, wherein the sequence code is able to be converted into a computer model which is a n-ary tree.

5. A database according to claim 1, wherein the rules sort the branched children of a structure, in order of priority, by:
increasing linkage, that is from lowest to highest; then,
length, that is longest to shortest; then,
alphabetically, that is from “a” to “z”; and then,
number of children, that is highest number first.

6. A database according to claim 1, 2 Dimensional the paths through a structure are defined as leading from the leaves of the structure to the root.

7. A database according to claim 1, used to represent carbohydrate molecules.

8. A database according to claim 1, used to represent sugars.

9. A database according to claim 1, used to represent glycan structures.

10. A process for constructing a database according to claim 1, comprising the following steps:
selecting a set of possible structures which may contain desired substructures;
representing each possible structure as a series of paths leading from the distal end of each branch back to root of the structure; and
representing all the paths of each structure using a sequence code generated by rules which guarantee there is a single unique representation for any structure.

11. A process for searching a database according to claim 1, to find all the structures that contain a given substructure within them, the method comprising the following steps:
parsing a query substructure into linear query paths, each of which extends from the distal end of a branch to the root of its structure;
inserting the query paths into the database; and
identifying a list of candidate structures in the database which contain the same linear paths as the query paths.

12. A process according to claim 11, wherein the identifying step is done by first identifying a first set of candidates that contain a linear path the same as a first query path, then identifying a second set of candidates, from the first set, that also contain a linear path the same as a second query path, and so on until a list is identified of candidate structures containing all the query paths;
then, validating the list of candidate structures by testing each candidate structure using a tree searching algorithm to determine whether it has the same topology within it as the query structure, to produce a validated list of candidate structures which contain the same linear paths as the query structure arranged with the same topology.

13. A process according to claim 12, wherein the validating step is done by:
parsing the listed candidate structures and the query structure to create objects;
testing each candidate structure object in turn;
traversing each node in the candidate structure under test, starting from the root;
checking, at every node, whether the type (name) of the node (monosaccharide) is the same as that of the root in the query structure;
determining that the query structure exists in the candidate structure if the query tree root node has no children; and
determining that the query structure does not exist in the candidate structure rooted at that node if the query tree root node has more branches, children, than the current node;
otherwise, determining that the query structure does not exist rooted at the current node if any of the linkages between the query tree root node and its children do not exist between the current node and its children.

14. A process according to claim 13, wherein the order in which linkages are checked are from lowest non-reducing terminal linkage to highest non-reducing terminal linkage; unknown linkages are sorted higher than other linkages; and the ordering of branches ensures that the largest branches are always searched for first.

15. A process according to claim 14, wherein recursive elimination is used to verify that the query structure exists rooted at the current node.

16. A process according to claim 15, wherein, if at any time a match does not occur between the children/linkages/names, the two branches are not considered as matched.

17. A process according to claim 16, wherein, otherwise, the branches are considered as matched, and the linkage used right at the start of the procedure is marked as eliminated, and will not be checked again.

18. A process according to claim 17, wherein, unknown linkages are dealt with by allowing for wild-cards within the query paths; the wild-cards match up with any value; and if a branch is attached on an unknown linkage, the process will check to see if the branch exists firstly in the list of known branches followed by the unknown branches.
